(19) United States
(12) Patent Application Publication
(10) Pub. No.: US 2016/0020043 A1
(43) Pub. Date: Jan. 21, 2016

(54) DIP SWITCH WITH A CONDUCTIVE SPRING LEAF

(71) Applicant: Jui-Hsiang LIN, New Taipei City (TW)

(72) Inventor: Jui-Hsiang LIN, New Taipei City (TW)

(21) Appl. No.: 14/803,756

(22) Filed: Jul. 20, 2015

(30) Foreign Application Priority Data
Jul. 21, 2014 (CN) 201420403172.9

(51) Int. Cl. H01H 13/14

(52) U.S. Cl. CPC H01H 13/14; H01H 2221/044

(57) ABSTRACT

A dip switch with a conductive spring leaf includes primarily a dip switch, a conductive terminal and a conductive spring leaf. A base of the conductive spring leaf is extended with a bending part, a tail end of which is provided with a suspended elastic contact member. When the dip switch is toggled, the conductive terminal in the dip switch will contact the elastic contact member of the bending part to achieve the purpose of conducting the electric current. Through the suspension design of the elastic contact member, the compression space between the conductive terminal and the elastic contact member is increased, which can intensify the stability in contact between the conductive terminal and the elastic contact member, as well as can avoid the problem of causing elastic fatigue easily when the dip switch is pressed down excessively.

### BACKGROUND OF THE INVENTION

a) Field of the Invention

The present invention relates to a dip switch with a conductive spring leaf, and more particularly to a conductive spring leaf structure which is used in a dip switch to increase stability in contact for conducting electricity and to avoid elastic fatigue.

b) Description of the Prior Art

Referring to FIG. 1 and FIG. 2, it shows a conductive spring leaf 1 which is often used in an existing dip switch 2. The conductive spring leaf 1 includes primarily a base 11 which is extended toward two sides with at least an elastic arm 12, and is disposed at a bottom of a push button 21 of the dip switch 2. By toggling the push button 21 back and forth, the conductive spring leaf 1 will be driven to move, such that when the elastic arms 12 at two sides of the conductive spring leaf 1 contact or do not contact a conductive terminal 22 in the dip switch 2, the electric current can be conducted or disconnected. As the elastic arms 12 of the conductive spring leaf 1 are made of a conductive metal, and are bent by a pre-determined angle through ramjet in the manufacturing process, the elastic arms 12 are provided with some elasticity effect. However, the metal itself is always provided with a specific modulus of elasticity; therefore, after being bent by a pre-determined angle, the metal will not be able to be fixed effectively at the required bending angle as the metal material itself will rebound again, thereby resulting in loose contact. Moreover, when the conductive spring leaf 1 of a conventional dip switch 2 is formed in a lower die, the rebound function of the metal will induce a larger manufacturing tolerance in the bending angle to the conductive spring leaf 1, which may enable the bending angle of the conductive spring leaf 1 to be excessively large that when the push button 21 is executing an ON/OFF operation, the resistance force to push will be increased and the operation will not be smooth. Or, if the bending angle of the conductive spring leaf 1 is too small, then the push button 21 will push more loosely, which may even cause instable contact. Furthermore, when the movable conductive spring leaf 1 displaces to contact the non-movable conductive terminal 22 for conducting electricity, the conductive spring leaf 1 should have a larger pressure to abut the conductive terminal 22 in order to achieve good contact. But, the larger the pressure, the easier the conductive spring leaf 1 will be deformed. If the pressure is too large for the conductive spring leaf 1 to withstand, then the conductive spring leaf 1 will lose the elasticity to be unable to rebound and even cannot restore to the original bending angle, due to the excessive deformation.

Accordingly, how to improve the abovementioned shortcomings is the technical issue to be solved by the present inventor.

### SUMMARY OF THE INVENTION

The primary object of the present invention is to disclose a dip switch with a conductive spring leaf, wherein a base of the conductive spring leaf is extended with a bending part, a tail end of which is provided with a suspended elastic contact member, such that when the dip switch is toggled, a conductive terminal in the dip switch can contact the elastic contact member of the bending part to conduct the electric current. Through the suspension design of the elastic contact member, the compression space between the conductive terminal and the elastic contact member is increased, which can intensity stability in contact between the conductive terminal and the elastic contact member and can avoid the problem of causing elastic fatigue easily when the dip switch is pressed down excessively.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional external view of a prior art.

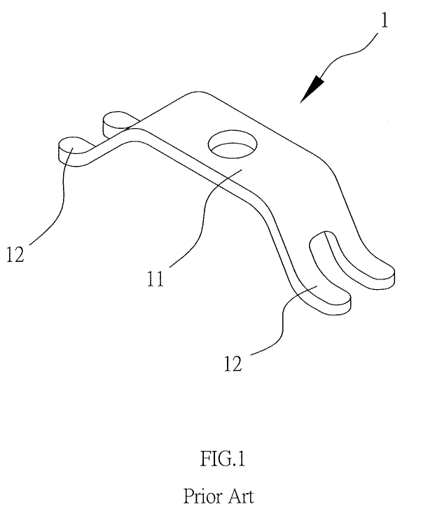

FIG. 2 shows a schematic view of a state of use of the prior art.

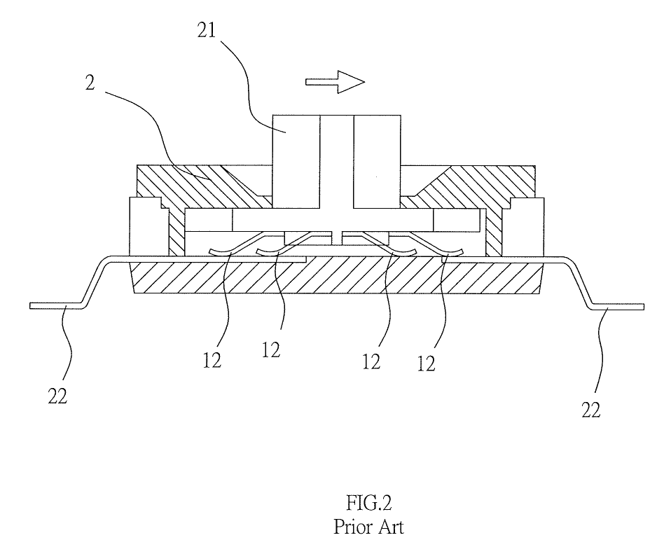

FIG. 3 shows a cutaway view of the present invention.

FIG. 4 shows a first schematic view of a state of use of the present invention.

FIG. 5 shows a second schematic view of the state of use of the present invention.

FIG. 6 shows a schematic view of a further state of use of the present invention.

FIG. 7 shows a first schematic view of another state of use of the present invention.

FIG. 8 shows a second schematic view of another state of use of the present invention.

FIG. 9 shows a third schematic view of another state of use of the present invention.

FIG. 10 shows a fourth schematic view of another state of use of the present invention.

### DETAILED DESCRIPTION OF THE PREFERRED EMBODIMENTS

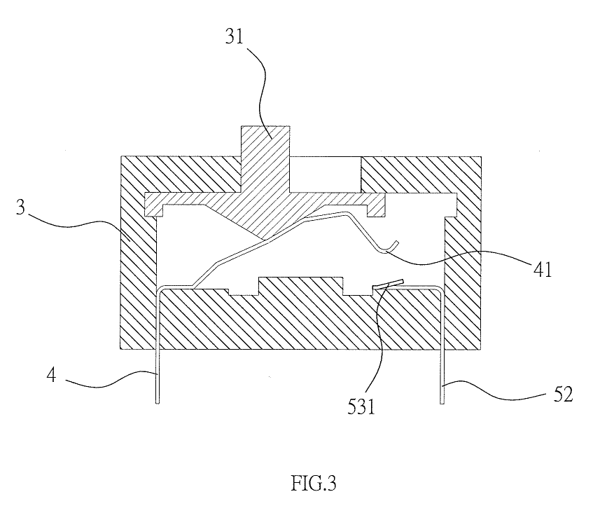

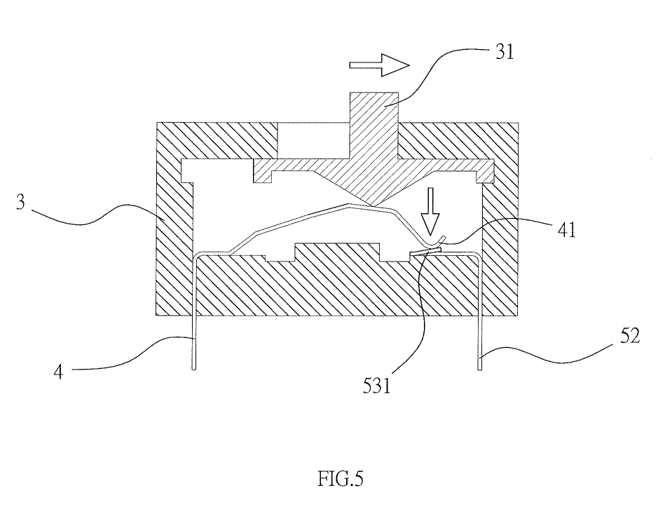

Referring to FIGS. 3 to 5, it shows a cutaway view, a first schematic view of a state of use, and a second schematic view of a state of use, of the present invention. It can be seen clearly from the drawings that a dip switch with a conductive spring leaf comprises primarily a dip switch 3 which is provided with a push button 31, a conductive terminal 4 which is disposed in the dip switch 3 and an end of which is extended with a contact portion 41, and a conductive spring leaf 5 which is disposed in the dip switch 3 and includes a base 51 and a bending part 53. A side of the base 51 is extended with a pin 52, and a tail end of the bending part 53 is provided with a suspended elastic contact member 531. The base 51 is provided additionally with a positioning hole 510 to fix the base 51 in the dip switch 3.

The base 51 is disposed in the dip switch 3 through the positioning hole 510. After the push button 31 of the dip switch 3 has been toggled, the push button 31 will squeeze the contact portion 41 of the conductive terminal 4 in the dip switch 3, forcing the contact portion 41 to move downward, such that the contact portion 41 can contact the elastic contact member 531 of the conductive spring leaf 5, thereby achieving the purpose of conducting the electric current.

Accordingly, the elastic contact member 531 of the conductive spring leaf 5 is suspended and bent upward in order to increase the compression space between the contact portion 41 of the conductive terminal 4 and the elastic contact member 531 of the conductive spring leaf 5. Basically, after the push button 31 of the dip switch 3 has been toggled, the contact portion 41 of the conductive terminal 4 will contact the elastic contact member 531 of the conductive spring leaf 5, and the contact portion 41 and the elastic contact member 531 will operate at a same time. In addition, as being suspended, the elastic contact member 531 is elastic. Therefore, when the contact portion 41 of the conductive terminal 4 contacts and abuts the elastic contact member 531, the contact portion 41 and the elastic contact member 531 can contact with each other more stably by the elasticity of the elastic contact member 531. Basically, as the contact portion 41 extended from the conductive terminal 4 and the elastic contact member 531 of the conductive spring leaf 5 are all elastic, the compression resulted from the elasticity of the two can be used to form good contact. Additionally, as the contact portion 41 and the elastic contact member 531 are all elastic, under the condition that the compression stroke is equally distributed between the two, there will be no deformation caused by over-compression like the prior art. Therefore, the present invention can maintain a good effect of conducting the electricity. Moreover, when the contact portion 41 of the conductive terminal 4 contacts and abuts the elastic contact member 531, the bending part 53 will primarily be used as the force point, not just using the elastic contact member 531 to withstand the force alone. Therefore, even the dip switch 3 is pressed down excessively, the elasticity of the elastic contact member 531 can be still maintained without causing elastic fatigue easily.

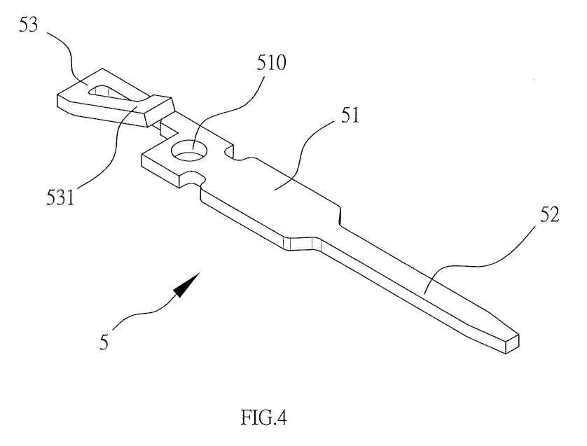

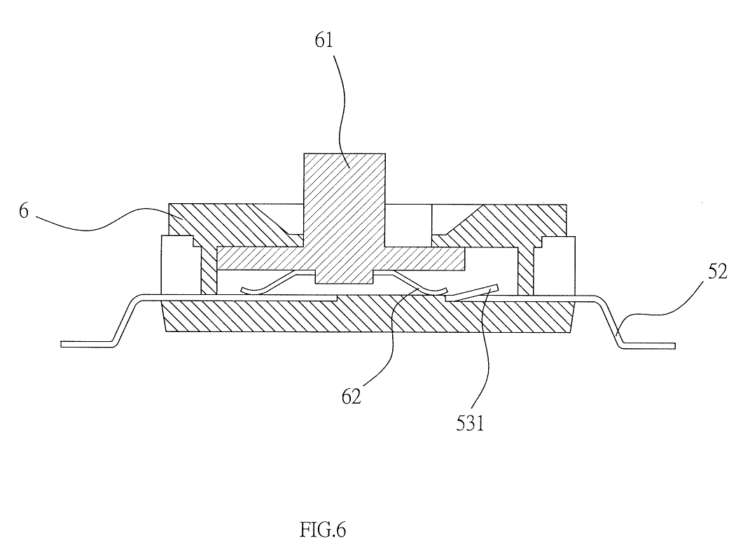

On the other hand, as shown in FIG. 4 and FIG. 6, it is another kind of dip switch 6, wherein the conventional conductive spring leaf of the dip switch 6 is replaced by the conductive spring leaf 5 of the present invention. As the pin 52 of the conductive spring leaf 5, the bending part 53 and the elastic contact member 531 are all extended from the base 51, an integrated configuration is formed. Therefore, even for the dip switch 6 that is different from the abovementioned embodiment or for other dip switch in a different structure or type, the conductive spring leaf 5 of the present invention can be used instead.

Accordingly, in comparison with that for the conventional conductive spring leaf, due to the modulus of elasticity of the metal itself, after the metal has been bent by a specific angle, the metal cannot be fixed effectively at the required bending angle because the metal is affected by the rebound of the metal material itself, thereby resulting in loose contact. However, for the conductive spring leaf 5 of the present invention, through the suspension design of the elastic contact member 531, the compression space can be increased to intensify stability in contact, and the problem of elastic fatigue can be avoided.

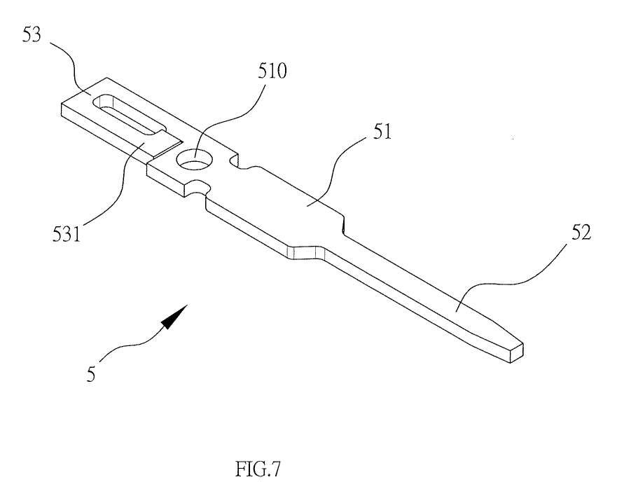

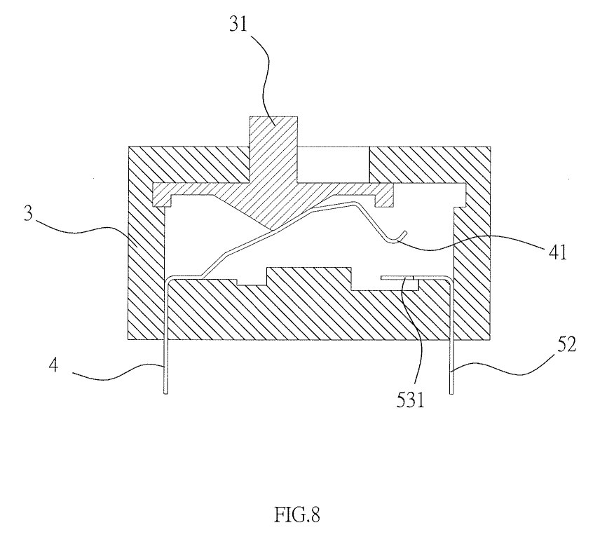

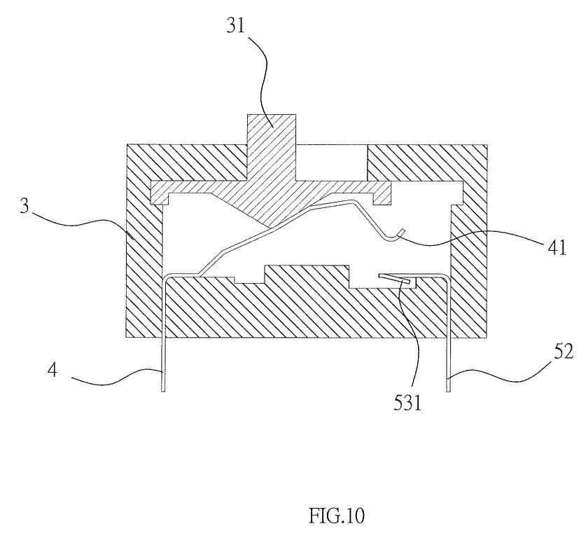

Referring to FIGS. 7 to 10, it shows schematic views of another state of use of the present invention. It can be seen clearly from the drawings that through the positioning hole 510 on the base 51, the base 51 can be disposed in the dip switch 3. After the push button 31 of the dip switch 3 has been toggled, the push button 31 will squeeze the conductive terminal 4 in the dip switch 3, forcing the contact portion 41 of the conductive terminal 4 to move downward, such that the contact portion 41 can contact the elastic contact member 531 of the conductive spring leaf 5, thereby achieving the purpose of conducting the electric current.

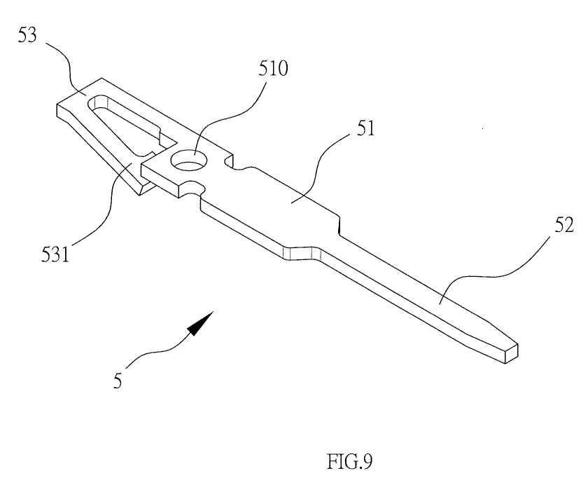

Accordingly, in comparison with that in the abovementioned embodiment, the elastic contact member 531 at the tail end of the bending part 53 is bent upward, the elastic contact member 531 of the present embodiment is parallel (as shown in FIG. 7) and bent downward (as shown in FIG. 9); therefore, the configuration of the elastic contact member 531 is not the same in order to fit different types of conductive terminal 4. However, no matter the elastic contact member 531 is bent upward as described above or is parallel and bent downward as in the present embodiment, the compression space can be increased, the stability in contact can be intensified, and the problem of elastic fatigue can be avoided as the elastic contact member 531 is always suspended.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A dip switch with a conductive spring leaf, comprising:
a dip switch, wherein the dip switch being provided with a push button;
a conductive terminal, wherein the conductive terminal being disposed in the dip switch and an end of the conductive terminal being extended with a contact portion;
a conductive spring leaf, wherein the conductive spring leaf being disposed in the dip switch and including a base and a bending part, wherein a side of the base is extended with a pin, and a tail end of the bending part is provided with a suspended elastic contact member;
by toggling the push button of the dip switch, the contact portion of the conductive terminal abutting the elastic contact member of the conductive spring leaf to conduct electric current; through the suspension design of the elastic contact member, the compression space between the conductive terminal and the conductive spring leaf being increased, which intensifies contact stability in between and avoids problem of causing elastic fatigue easily when the dip switch is pressed down excessively.

2. The dip switch with a conductive spring leaf according to claim 1, wherein the base of the conductive spring leaf is additionally provided with a positioning hole to fix the base in the dip switch.

3. The dip switch with a conductive spring leaf according to claim 1, wherein the elastic contact member is elastic provided with the suspension design of the elastic contact member.

4. The dip switch with a conductive spring leaf according to claim 1, wherein the elastic contact member is bent upward, parallel or bent downward.
